(19) United States
(12) Patent Application Publication
(10) Pub. No.: US 2026/0124735 A1
(43) Pub. Date: May 7, 2026

(54) Portable Woodworking Hole Puncher

(71) Applicant: Hangzhou Junting Network Technology Co., Ltd., Zhejiang (CN)

(72) Inventor: Yi YI, Zhejiang (CN)

(73) Assignee: Hangzhou Junting Network Technology Co., Ltd., Zhejiang (CN)

(21) Appl. No.: 19/437,939

(22) Filed: Dec. 31, 2025

(51) Int. Cl. B25H 1/00; B23B 47/28

(52) U.S. Cl. CPC B25H 1/0078; B23B 47/287

(57) ABSTRACT

The present disclosure relates to a portable woodworking hole puncher, comprising: a base plate; a support part, arranged on the base plate, for supporting a wood to be processed; a connecting part arranged on the base plate; a hole-punching mechanism pivotally connected to the connecting part, the hole-punching mechanism comprising a hole-punching drill bit for mounting an electric drill and a guiding structure, the guiding structure being used to guide the hole-punching drill bit to move precisely along a linear trajectory; and an angle-locking assembly arranged between the hole-punching mechanism and the connecting part.

### TECHNICAL FIELD

The present disclosure relates to the technical field of hole punchers, particularly to a portable woodworking hole puncher.

### BACKGROUND

Existing woodworking hole punchers exhibit several significant shortcomings that severely impact user experience and market suitability. First is the issue of size and weight; the overall dimensions are too large and the weight exceeds standards, not only occupying excessive storage space but also increasing the user’s physical burden when carrying, which is particularly inconvenient in scenarios requiring frequent movement. Second are core performance defects; frequent jamming during the hole-punching process can easily lead to irregular hole diameters, wood splitting, and significantly prolongs construction time, reducing work efficiency. Finally, there is insufficient adjustment stability; while parameter adjustments are supported, the fixing structure becomes loose after adjustment, causing positional deviation during punching, failing to ensure punching accuracy, and making it difficult to meet carpenters’ requirements for craft details. This presents a significant gap from the market’s practical demand for efficiency, precision, and portability.

For example, U.S. Patent US4082474A discloses a portable drill bit attachment with a base and frame, using guide rods and trunnions to facilitate adjustable positioning and angled drilling, including a vise clamp for precise hole positioning and depth control. Although it achieves angle adjustment of the drill bit through the guide rod and trunnion structure and uses the vise clamp for workpiece fixation, in terms of the fastening method after adjustment, it relies solely on nuts for locking. This method is prone to loosening under continuous drilling vibrations, leading to unstable drill bit guidance and ineffective assurance of drilling accuracy.

The present disclosure provides a portable woodworking hole puncher to solve the problems raised in the above background art.

To achieve the above-mentioned object of the present disclosure, the present disclosure adopts the following technical solutions:

A portable woodworking hole puncher includes a base plate; a support part arranged on the base plate for supporting a wood to be processed; a connecting part, arranged on the base plate; a hole-punching mechanism pivotally connected to the connecting part, the hole-punching mechanism comprising a hole-punching drill bit for mounting an electric drill and a guiding structure, the guiding structure being configured to guide the hole-punching drill bit to move precisely along a linear trajectory; and an angle-locking assembly arranged between the hole-punching mechanism and the connecting part for locking the hole-punching mechanism at a selected rotation angle.

A portable woodworking hole puncher includes a base plate; a support part arranged on the base plate for supporting a wood to be processed; a connecting part arranged on the base plate; a hole-punching mechanism rotatably connected to the connecting part, comprising a hole-punching drill bit for mounting an electric drill and a guiding structure for guiding the hole-punching drill bit to move along a linear trajectory; an angle-locking assembly arranged between the hole-punching mechanism and the connecting part for locking the hole-punching mechanism at a selected rotation angle to ensure stability and precision of hole punching; and a fixing assembly arranged on the base plate, comprising an insertion rod and a positioning mechanism for positioning the woodworking hole puncher.

The beneficial effects of the present disclosure compared to the prior art are as follows:

The M-shaped top design of the support plate enables positioning and hole-punching of round rod wood. Combined with its adjustable expansion design, it enhances the versatility and stability of wood fixation. The hole-punching mechanism guides the moving block and hole-punching drill bit through the first vertical rod and second vertical rod for precise linear motion. Coupled with the reset assistance of the elastic element, it ensures the verticality and smoothness of the hole-punching process, improving hole quality. The dual locking mechanism of the limiting mechanism and the locking mechanism, combined with the connecting plate with scale, allows for precise and reliable adjustment and fixation of the hole-punching angle, meeting the need for multi-angle accurate hole-punching. The entire device has a compact structure, with clear functions and good synergy among components. While ensuring professional-level hole-punching accuracy, it offers good portability and ease of operation, suitable for various woodworking scenarios.

### BRIEF DESCRIPTION OF DRAWINGS

The drawings, which form a part of this application, are provided to further illustrate the present disclosure. The illustrative embodiments of the present disclosure and the descriptions thereof are used to explain the present disclosure and do not constitute an undue limitation of the present disclosure. In the drawings:

FIG. 1 is a perspective schematic diagram of an embodiment provided by the present disclosure.

FIG. 2 is a schematic diagram of the installation and usage structure in FIG. 1.

FIG. 3 is a front view structural schematic diagram of the embodiment shown in FIG. 1.

FIG. 4 is a perspective schematic diagram of the embodiment shown in FIG. 3.

FIG. 5 is a structural schematic diagram of the base plate and the limiting mechanism of the embodiment shown in FIG. 3.

FIG. 6 is an exploded schematic diagram of the limiting mechanism of the embodiment shown in FIG. 5.

FIG. 7 is a cross-sectional view of the housing, pull plate, and clamping rod of the embodiment shown in FIG. 6.

FIG. 8 is an exploded schematic diagram of the handle, sliding block, and connecting bolt of the embodiment shown in FIG. 1.

FIG. 9 is a schematic diagram of a first usage method of the positioning mechanism provided by the present disclosure.

FIG. 10 is a schematic diagram of a second usage method of the positioning mechanism provided by the present disclosure.

Reference signs: Base Plate (100); Insertion Rod (101); Bottom Hole (102); Support Plate (200); Connecting Plate (300); Sliding Slot (301); Scale (302); Hole-Punching Mechanism (400); First Connecting Block (401); Second Connecting Block (402); First Vertical Rod (403); Second Vertical Rod (404); Moving Block (405); Elastic Element (406); Hole-Punching Drill Bit (407); First Limiting Block (408); Second Limiting Block (409); U-Shaped Connecting Buckle (410); Limiting Bolt (411); Limiting Mechanism (500); Housing (501); Pull Plate (502); Clamping Rod (503); Clamping Hole (504); Handle (600); Sliding Block (601); Connecting Bolt (602); Baffle Plate (603); Positioning Mechanism (700); Connecting Rod (701); Adjusting Plate (702); Adjusting Bolt (703).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms "comprising" and/or "including" are used in this specification, they specify the presence of features, steps, operations, equipment, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

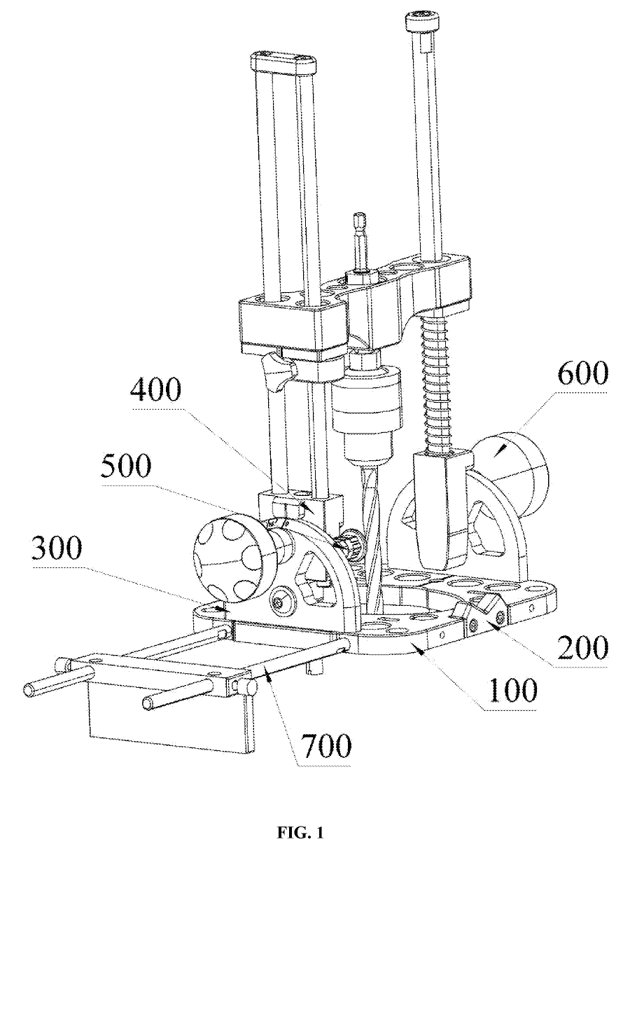

As shown in FIG. 1, a portable woodworking hole puncher includes a base plate 100. The base plate 100 serves as the foundational component of the entire woodworking hole puncher, made of high-strength aluminum alloy material, providing strong supporting force while maintaining a light weight for easy portability and operation. Both ends of the top of the base plate 100 are respectively provided with connecting plates 300, which are arc-shaped. The other two ends of the base plate 100 are provided with support plates 200 for securing and supporting the wood. The top of the support plates 200 is M-shaped, allowing round rod wood to be placed between two opposing support plates 200. This design enables center positioning of round rod-shaped wood. The connecting plates 300 are equipped with a hole-punching mechanism 400 for punching holes in the wood.

In other embodiments (not shown), adjustable support arms are provided on both sides of the support plate 200 for adjusting the fixing angle and position of the wood. The height of the support plate 200 is adjustable to accommodate wood of different thicknesses. Through a threaded adjustment system, users can adjust the height of the support plate 200 according to the thickness and type of wood to ensure stable support.

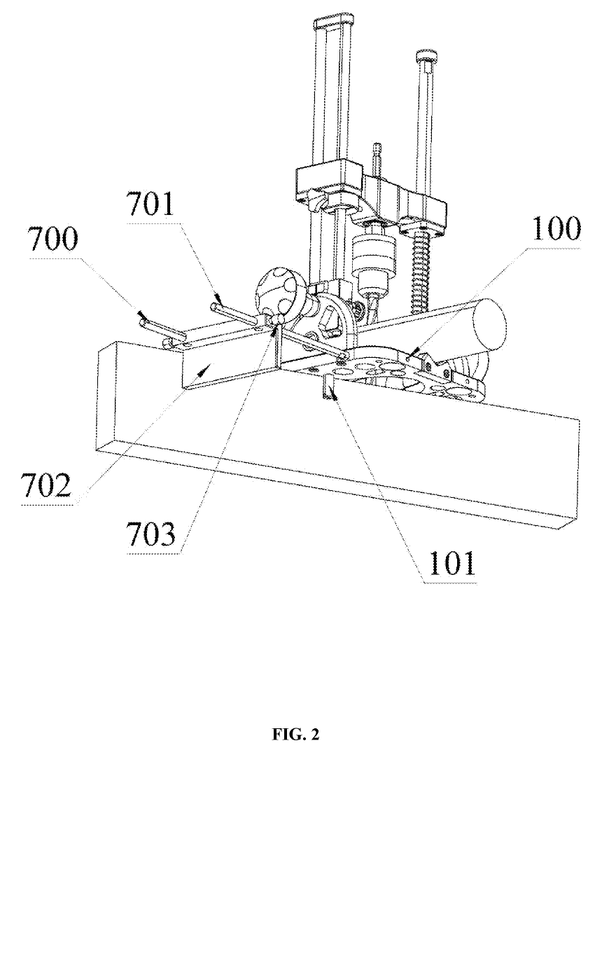

As shown in FIGS. 1 and 2, the bottom of the base plate 100 is provided with a bottom hole 102, and two symmetrically arranged insertion rods 101 are installed at the bottom of the base plate 100, with the two insertion rods 101 symmetrically distributed around the bottom hole 102. During use, place the base plate 100 on the narrow board to be punched, so that the two insertion rods 101 abut against both sides of the narrow board respectively. At this point, the bottom hole 102 aligns with the center of the narrow board. The hole-punching mechanism 400 can then perform punching operations at this center. By adjusting the position of the base plate 100 while keeping the two insertion rods 101 abutting against both sides of the narrow board, a plurality of center holes can be machined on the narrow board.

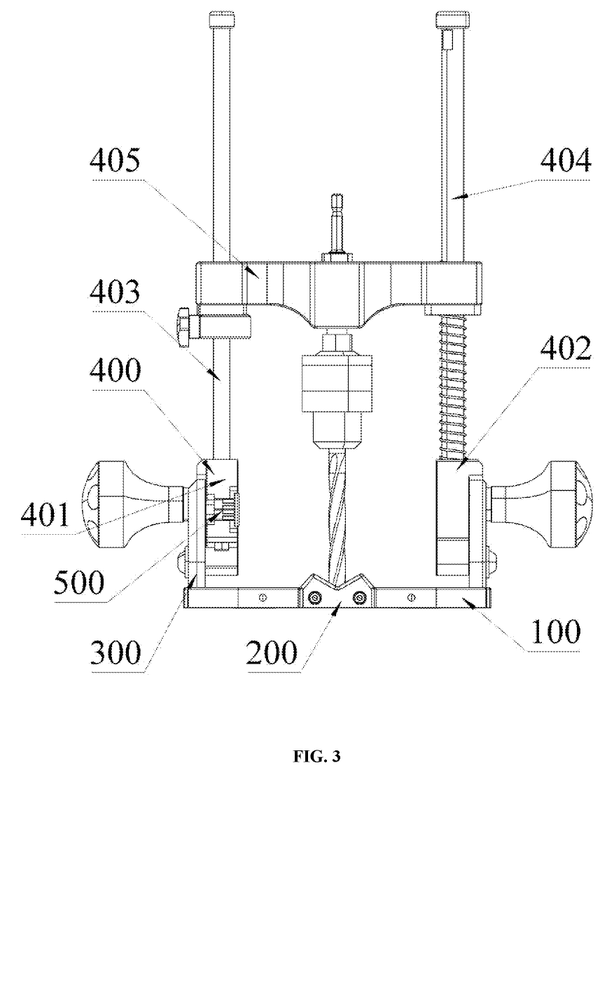

As shown in FIGS. 3 to 5, the hole-punching mechanism 400 includes a first connecting block 401 and a second connecting block 402, which are respectively hinged to two connecting plates 300. The top of the first connecting block 401 is vertically provided with two first vertical rods 403, and the top of the second connecting block 402 is vertically provided with a second vertical rod 404. The first vertical rods 403 and the second vertical rod 404 are arranged in parallel. A moving block 405 is slidably mounted on the two first vertical rods 403 and the second vertical rod 404. The middle of the moving block 405 is vertically provided with a hole-punching drill bit 407. By connecting a power drill to the hole-punching drill bit 407, the hole-punching drill bit 407 can be driven to work. An elastic element 406 is sleeved on the outside of the second vertical rod 404, with both ends of the elastic element 406 abutting against the moving block 405 and the second connecting block 402 respectively. The elastic element 406 resets and provides support for the moving block 405 and the hole-punching drill bit 407.

The tops of the two first vertical rods 403 are provided with first limiting blocks 408, and the top of the second vertical rod 404 is provided with a second limiting block 409. The first limiting blocks 408 and the second limiting block 409 restrict the moving distance of the moving block 405 and the hole-punching drill bit 407, preventing the moving block 405 from moving out under the action of the elastic element 406.

A U-shaped connecting buckle 410 is provided on the first vertical rod 403, and a limiting bolt 411 is threadedly connected inside the U-shaped connecting buckle 410. After the moving block 405 is moved to a suitable position, tighten the limiting bolt 411 to position the moving block 405, preventing it from moving on the first vertical rod 403 and the second vertical rod 404.

Specifically, after connecting the electric drill to the hole-punching drill bit 407, start the electric drill, which drives the hole-punching drill bit 407 to operate. At this point, pushing the electric drill drives the moving block 405 to slide on the first vertical rod 403 and the second vertical rod 404, controlling the up-and-down movement of the hole-punching drill bit 407, thereby achieving precise hole-punching operations. By adjusting the contact point between the hole-punching drill bit 407 and the wood, holes of different depths can be achieved. To ensure the hole-punching drill bit 407 is not affected by external forces during operation, the elastic element 406 allows the hole-punching drill bit 407 and the moving block 405 to reset when not in use.

In other embodiments (not shown), the top of the support plate 200 features an adjustable U-shaped design. Through support arms on both sides, users can adjust the width of the support plate 200 according to the size of the wood. The support plate 200 incorporates a pneumatic system, allowing users to change the hardness of the support part by adjusting the air pressure, thereby providing more precise support for different types of wood. The design of the connecting plate 300 is more compact, and it includes an automatic docking device; when the base plate 100 and the connecting plate 300 are installed, their positions can be automatically locked, reducing manual operations. The hole-punching mechanism 400 uses an improved guiding structure, including multi-segment adjustable slide rails, further enhancing the movement precision of the hole-punching drill bit 407.

In other embodiments (not shown), the design of the support plate 200 adopts a multifunctional combination approach. The top of the support plate 200 is not only M-shaped but also incorporates magnetic support functionality, which can magnetically adhere to the surface of the wood to be processed, thereby reducing the likelihood of wood slippage. At the same time, adjustable side support plates are installed on both sides of the support plate 200; these side support plates can adjust the angle and position of the wood through simple locking mechanisms. Regarding the hole-punching mechanism 400, an integrated electric screw adjustment device has been added, allowing users to adjust the hole-punching depth. Through electric adjustment, the hole-punching drill bit 407 can precisely control its penetration depth into the wood, meeting the needs for holes of different depths.

In other embodiments (not shown), the base plate 100 integrates a foldable support stand. When in use, the support stand can support the entire hole-punching device, facilitating operation; when not in use, it can be folded to save storage space. The top of the support plate 200 is an adjustable inclined surface; users can adjust the support plate 200 to different tilt angles through an adjustment system, thereby supporting hole-punching on wood at various angles. Additionally, the hole-punching mechanism 400 is equipped with an automatic lubrication system that can automatically add lubricant to the hole-punching drill bit 407 during the hole-punching process, reducing friction and improving hole-punching efficiency. This automatic lubrication function is particularly suitable for prolonged use or large-scale production, effectively extending the drill bit’s service life.

As shown in FIGS. 1 and 2, one end of the base plate 100 is provided with a positioning mechanism 700. The positioning mechanism 700 includes two connecting rods 701, which are arranged on the same side of the base plate 100 and are parallel to each other. An adjusting plate 702 is slidably mounted on the outer side of the two connecting rods 701. The adjusting plate 702 is L-shaped, and both inner sides of the adjusting plate 702 are threadedly connected with adjusting bolts 703. One end of each adjusting bolt 703 abuts against the outer side of the connecting rod 701. The adjusting plate 702 can be fixed to the connecting rods 701 by tightening the adjusting bolts 703, thereby positioning the hole punch through the adjusting plate 702.

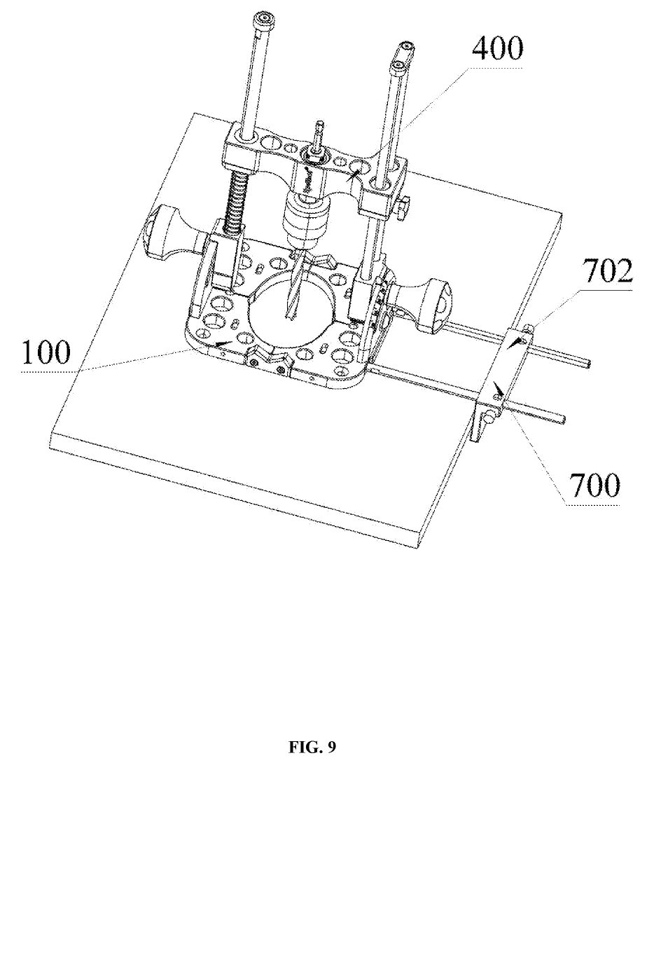

As shown in FIG. 9, when installing the woodworking hole punch, place the base plate 100 on the wooden board, aligning the hole-punching drill bit 407 of the hole-punching mechanism 400 with the intended hole location on the board. Then, adjust the position of the adjusting plate 702 so that it abuts against the outer side of the wood, and tighten the adjusting bolts 703 to secure the adjusting plate 702. At this point, the adjusting plate 702 abuts the wooden board, positioning the hole punch, allowing drilling to begin. This prevents deviation during punching and improves the stability of the hole punch.

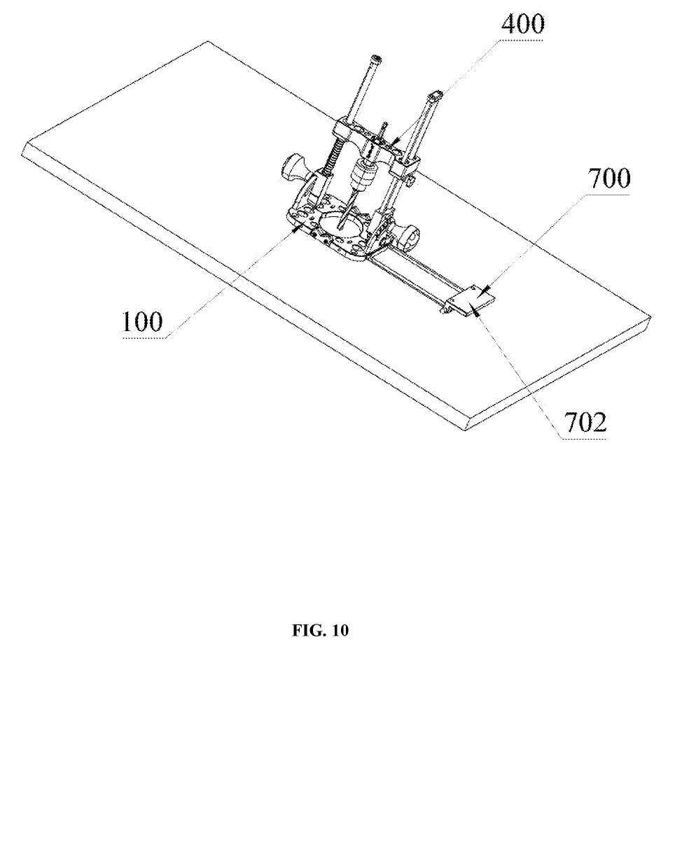

As shown in FIG. 10, when needing to punch a hole at the center of a wooden board, place the base plate 100 on the board, aligning the hole-punching drill bit 407 of the hole-punching mechanism 400 with the intended hole location. Remove and flip the adjusting plate 702 so that the base plate 100 is flush with the bottom of the adjusting plate 702. Then, install the adjusting plate 702 onto the connecting rods 701 using the adjusting bolts 703. Pressing the adjusting plate 702 by hand allows drilling to begin, preventing deviation during punching and improving the stability of the hole punch.

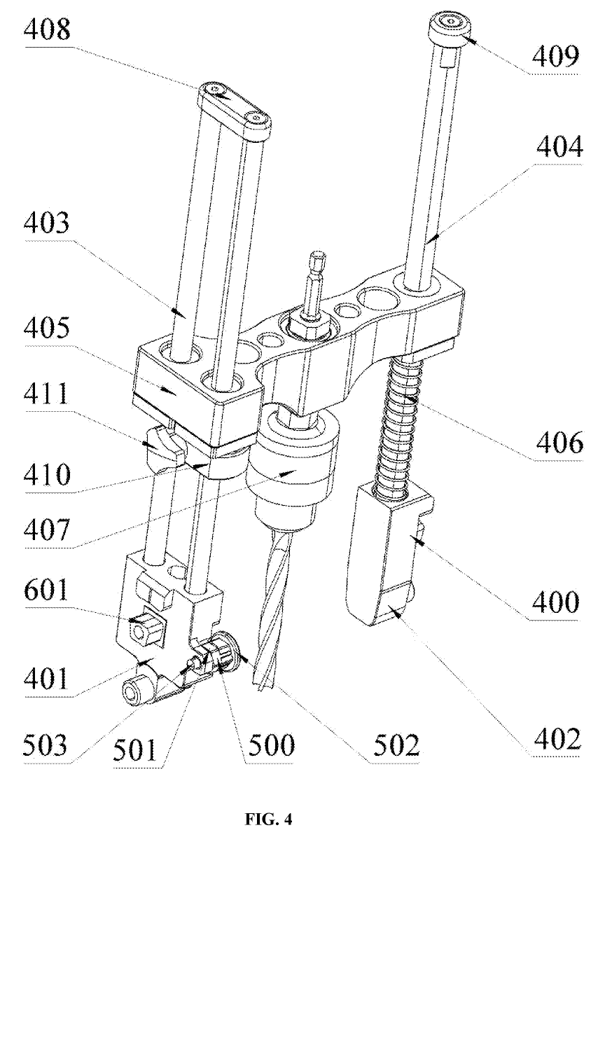

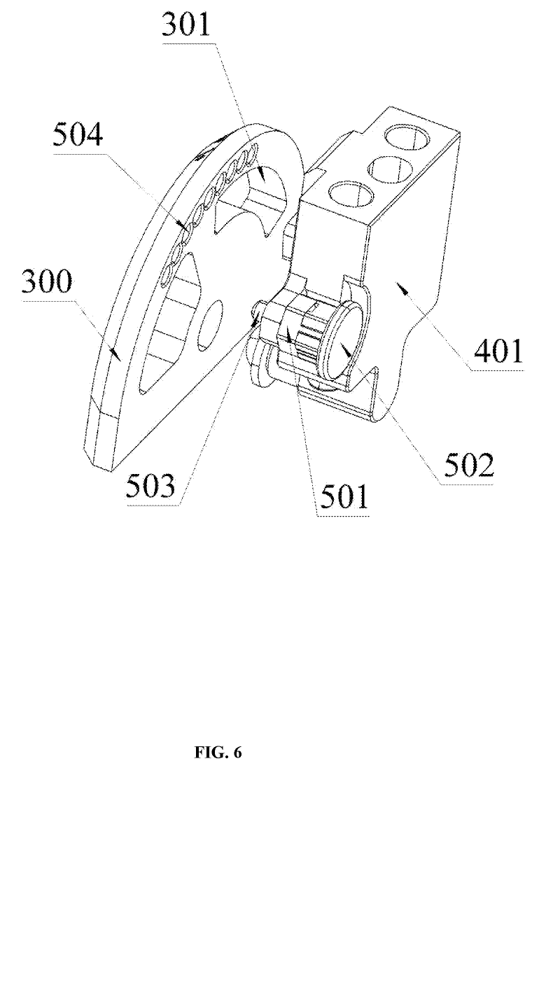

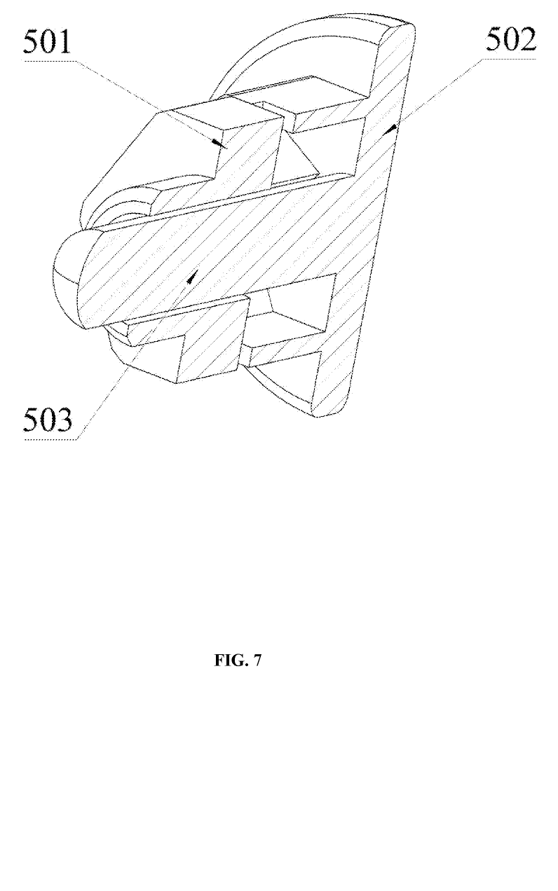

As shown in FIGS. 4 to 7, one end of the first connecting block 401 is provided with a limiting mechanism 500. The limiting mechanism 500 includes a housing 501 arranged at one end of the first connecting block 401. One end of the housing 501 is provided with a pull plate 502, and one end of the pull plate 502 is provided with a clamping rod 503 that passes through the housing 501. The pull plate 502 is connected to the housing 501 in a sliding manner, allowing the pull plate 502 to drive the clamping rod 503 to move accordingly when angle adjustment is needed.

The limiting mechanism 500 further includes a plurality of clamping holes 504 arranged on the side of the connecting plate 300 close to the first connecting block 401. The plurality of clamping holes 504 are equidistantly distributed in an arc. The side of the connecting plate 300 away from the first connecting block 401 is provided with a scale 302. The design of the clamping holes 504 allows the clamping rod 503 to be inserted at different angular positions, thereby achieving precise locking of the angle of the hole-punching mechanism 400.

In this embodiment, the end of the clamping rod 503 is designed in a circular or polygonal shape, ensuring precise engagement with the clamping hole 504 and effectively preventing the clamping rod 503 from dislodging during operation. By pulling the pull plate 502, the pull plate 502 drives the clamping rod 503 to slide within the clamping hole 504. When the user needs to adjust the angle of the hole-punching mechanism 400, the clamping rod 503 can be completely removed from the clamping hole 504, placing the hole-punching mechanism 400 in a loose state for easy angle adjustment.

Furthermore, the movement of the clamping rod 503 is not limited to manual pulling; users can also opt to control the movement of the pull plate 502 through electric or pneumatic devices, allowing the clamping rod 503 to be removed from the clamping hole 504 more precisely and effortlessly, thereby enabling automatic angle adjustment. This design is particularly suitable for scenarios requiring high-precision adjustments, such as industrial woodworking.

When angle locking of the hole-punching mechanism 400 is required, the user determines the desired angle through the scale 302, then inserts the clamping rod 503 into the corresponding clamping hole 504. The end of the clamping rod 503 tightly engages with the clamping hole 504, completing precise positioning of the hole-punching mechanism 400. The limiting mechanism 500 ensures that the hole-punching mechanism 400 remains stable throughout the entire working process, preventing positional deviation due to external impacts or vibrations, thereby guaranteeing punching accuracy and operational stability.

In other embodiments (not shown), the design of the clamping holes 504 in the limiting mechanism 500 is not limited to arc-shaped equidistant distribution. Rectangular, elliptical, or other shapes of clamping holes can be adopted, adjusting the number and shape of the clamping holes 504 according to specific application needs, making the angle adjustment of the hole-punching mechanism 400 more flexible to meet various angle adjustment requirements.

In other embodiments (not shown), the clamping rod 503 of the limiting mechanism 500 can also feature an adjustable length design, allowing users to adjust the length of the clamping rod 503 as needed for use in punching operations of different heights and widths. By adjusting the length of the clamping rod 503, the adaptability of the limiting mechanism 500 can be further enhanced, making it suitable for various woodworking scenarios.

In other embodiments (not shown), the limiting mechanism 500 can also integrate a spring device, used to automatically push the clamping rod 503 back into the clamping hole 504 after the user adjusts the angle, ensuring that the clamping rod 503 can securely fix the hole-punching mechanism 400 and maintain angle stability over prolonged use.

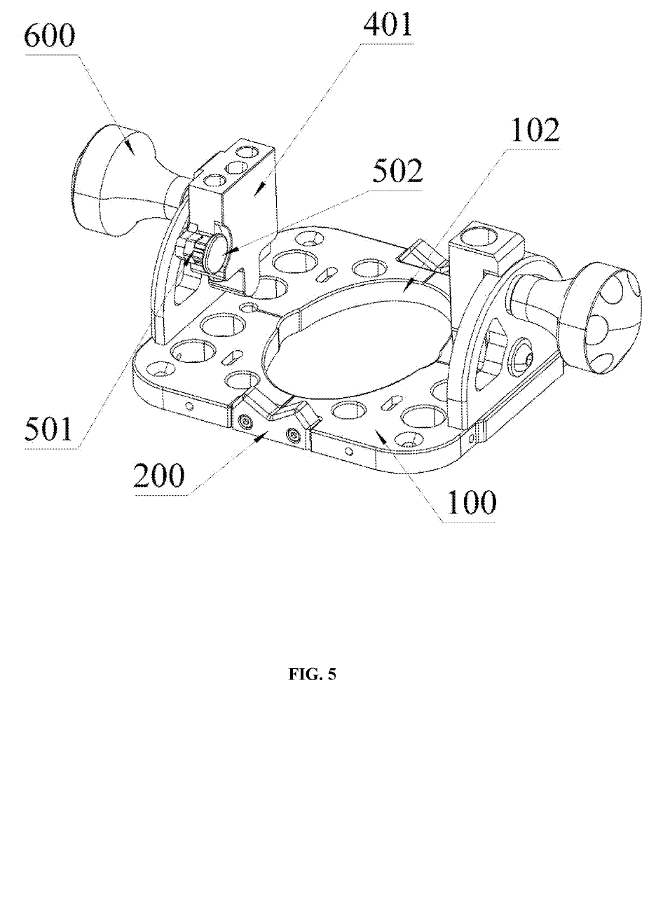

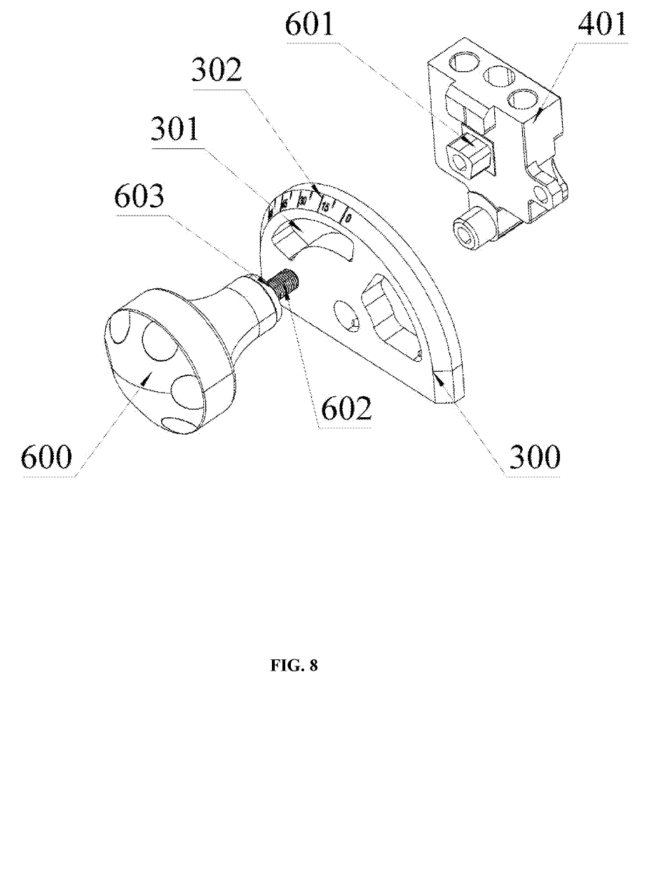

As shown in FIGS. 5 to 8, the connecting plate 300 is provided with an arc-shaped sliding slot 301. The design of the sliding slot 301 allows the first connecting block 401 and the second connecting block 402 to slide relative to each other, thereby adjusting the angle or position of the hole-punching mechanism 400. On the side of the first connecting block 401 and the second connecting block 402 close to the connecting plate 300, sliding blocks 601 are provided. The sliding blocks 601 slide smoothly within the sliding slot 301 through rollers or sliding accessories, ensuring stable adjustment of the hole-punching mechanism 400. The interior of each sliding block 601 is threadedly connected with a connecting bolt 602, which serves a fixing and adjusting function. A baffle plate 603 is sleeved on the outer side of the connecting bolt 602. After the hole-punching mechanism 400 is adjusted, the baffle plate 603 acts as a restraint, preventing the sliding block 601 from sliding or detaching accidentally during adjustment, further enhancing the stability of the hole-punching mechanism 400. A handle 600 is provided on the outer side of the connecting bolt 602. By rotating the handle 600, the user can manually adjust the position of the connecting bolt 602 and precisely control the adjustment process of the hole-punching mechanism 400. Once the hole-punching mechanism 400 is adjusted, the user can turn the handle 600 to rotate the connecting bolt 602 within the sliding block 601. Rotating the connecting bolt 602 drives the baffle plate 603 to slide along the moving direction of the sliding block 601, causing the baffle plate 603 to abut against the inner wall of the connecting plate 300, thereby precisely securing the hole-punching mechanism 400. Through this adjustment mechanism, the hole-punching mechanism 400 can be firmly fixed at the desired position without shifting or loosening during the punching process, ensuring punching accuracy.

In other embodiments (not shown), the design of the sliding block 601 can be further optimized. For example, the surface of the sliding block 601 can be coated with a low-friction material (such as PTFE) to reduce friction in the sliding slot 301, improving the smoothness and stability during the adjustment of the hole-punching mechanism 400. Additionally, the roller design of the sliding block 601 can enhance its sliding performance, further reducing the operational force required during adjustment and making the use of the punch more convenient.

In other embodiments (not shown), the design of the sliding slot 301 and the sliding block 601 can also be combined with an automatic adjustment system. In such embodiments, the user can adjust the sliding position of the connecting blocks through an electric control device or pneumatic system, enabling the hole-punching mechanism 400 to automatically position itself at precisely set angles or positions. This feature is particularly suitable for large-scale industrial punching operations, as it can improve operational efficiency and reduce errors from manual operation.

In other embodiments (not shown), to prevent accidental loosening during adjustment, the sliding block 601 and connecting bolt 602 can be designed with a dual-locking mechanism. In addition to manually rotating the baffle plate 603, a spring locking device can be installed; when the connecting bolt 602 is rotated to the fixed position, the spring device automatically locks the bolt to prevent loosening during use. This additional safety mechanism ensures the stability and safety of the hole-punching mechanism during high-frequency or high-intensity operations.

In other embodiments (not shown), the design of the handle 600 can be customized according to user needs. Besides the traditional manual rotating handle 600, it can also be designed as a trigger-style handle or knob-style handle, allowing users to choose the most suitable adjustment method based on the operating environment and personal habits. The trigger-style handle is particularly suitable for large-scale production environments, providing rapid adjustment and positioning functions.

In summary, the present disclosure achieves the following technical effects:

The M-shaped top design of the support plate 200 enables centering and hole-punching of round wooden rods, and combined with its adjustable expansion design, it enhances the versatility and stability of wood fixation. The hole-punching mechanism 400 guides the moving block 405 and hole-punching drill bit 407 through the first vertical rod 403 and second vertical rod 404 to perform precise linear motion; coupled with the reset assistance of the elastic element 406, it ensures the verticality and smoothness of the hole-punching process, improving hole quality. The dual-locking mechanism of the limiting mechanism 500 and the locking mechanism, together with the connecting plate 300 featuring a scale 302, allows for precise and reliable adjustment and fixation of the hole-punching angle, meeting the demand for multi-angle accurate hole-punching. The entire device has a compact structure, with clear functions and good synergy among components; while ensuring professional-level hole-punching precision, it offers good portability and ease of operation, making it suitable for various woodworking scenarios.

In the description of the present disclosure, it should be appreciated that directional terms such as "front, rear, up, down, left, right", "horizontal, vertical, perpendicular, horizontal" and "top, bottom" etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms "inside, outside" refer to the inside and outside relative to the contour of each component itself.

For the convenience of description, spatial relative terms such as "on...", "above...", "on the upper surface of...", "upper" etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as "above other devices or structures" or "on other devices or structures" will subsequently be positioned as "below other devices or structures" or "under other devices or structures". Thus, the exemplary term "above" can include both "above" and "below" orientations. The device can also be positioned in other different ways (rotated 90 degrees or in other orientations), and the spatial relative descriptions used here should be interpreted accordingly.

In addition, it should be noted that the use of terms such as "first", "second" etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A portable woodworking hole puncher, comprising:
a base plate;
a support part arranged on the base plate for supporting a wood to be processed;
a connecting part, arranged on the base plate;
a hole-punching mechanism pivotally connected to the connecting part, the hole-punching mechanism comprising a hole-punching drill bit for mounting an electric drill and a guiding structure, the guiding structure being configured to guide the hole-punching drill bit to move precisely along a linear trajectory; and
an angle-locking assembly arranged between the hole-punching mechanism and the connecting part for locking the hole-punching mechanism at a selected rotation angle.

2. The portable woodworking hole puncher according to claim 1, wherein the support part is M-shaped, capable of effectively securing and supporting the wood, preventing the wood from sliding or tilting during a hole-punching process.

3. The portable woodworking hole puncher according to claim 1, wherein a height of the support part is adjustable, allowing the height of the support part to be adjusted according to woods of different thicknesses to accommodate processing needs of different woods.

4. The portable woodworking hole puncher according to claim 1, wherein the guiding structure comprises at least a first vertical rod and a second vertical rod that are vertically arranged, moving blocks are slidably arranged on the first vertical rod and the second vertical rod, the hole-punching drill bit is arranged on the moving block, and a hole-punching operation is performed by driving the hole-punching drill bit through the electric drill.

5. The portable woodworking hole puncher according to claim 4, wherein the hole-punching mechanism further comprises a first connecting block and a second connecting block, the first connecting block and the second connecting block are respectively hinged to the two connecting parts, and the first vertical rod and the second vertical rod are respectively arranged on the first connecting block and the second connecting block.

6. The portable woodworking hole puncher according to claim 5, wherein an elastic element is sleeved on the second vertical rod, the elastic element being configured to provide a restoring force and a supporting force to the moving block to move away from the base plate.

7. The portable woodworking hole puncher according to claim 4, wherein a first limiting block is provided at a top of the first vertical rod, and a second limiting block is provided at a top of the second vertical rod, for limiting a moving distance of the moving block.

8. The portable woodworking hole puncher according to claim 5, wherein the angle-locking assembly comprises a housing, a pull plate and a clamping rod, the housing is arranged on the first connecting block, the clamping rod is arranged inside the housing, and the pull plate is arranged at one end of the clamping rod; and
the angle-locking assembly further comprises a plurality of clamping holes arranged on the connecting part, and the clamping rod is inserted into the clamping holes to lock the hole-punching mechanism; and
the connecting part is provided with a scale for observing an angle of the hole-punching mechanism.

9. The portable woodworking hole puncher according to claim 8, wherein a sliding slot is provided on the connecting part, and both the first connecting block and the second connecting block are provided with sliding blocks that are slidably arranged inside the sliding slot; and
a connecting bolt is threadedly connected inside the sliding block, a baffle plate is sleeved on the connecting bolt, and one end of the connecting bolt is provided with a handle, with the baffle plate abutting against the connecting part to restrict rotation of the hole-punching mechanism.

10. The portable woodworking hole puncher according to claim 1, further comprising an insertion rod and a positioning mechanism, wherein the insertion rod is inserted into a bottom of the base plate, and the positioning mechanism is arranged at one end of the base plate for installation and positioning of the woodworking hole puncher.

11. The portable woodworking hole puncher according to claim 10, wherein the positioning mechanism comprises two parallel connecting rods; and
an adjusting plate is slidably arranged on each connecting rod, and an adjusting bolt is threadedly connected to the adjusting plate, with one end of the adjusting bolt abutting against an outer side of the connecting rod.

12. A portable woodworking hole puncher, comprising:
a base plate;
a support part arranged on the base plate for supporting a wood to be processed;
a connecting part arranged on the base plate;
a hole-punching mechanism rotatably connected to the connecting part, comprising a hole-punching drill bit for mounting an electric drill and a guiding structure for guiding the hole-punching drill bit to move along a linear trajectory;
an angle-locking assembly arranged between the hole-punching mechanism and the connecting part for locking the hole-punching mechanism at a selected rotation angle to ensure stability and precision of hole punching; and
a fixing assembly arranged on the base plate, comprising an insertion rod and a positioning mechanism for positioning the woodworking hole puncher.

13. The portable woodworking hole puncher according to claim 12, wherein the guiding structure comprises a second vertical rod and two first vertical rods, with the second vertical rod and the first vertical rods arranged in parallel; and
the guiding structure further comprises a moving block slidably arranged on the first vertical rods and the second vertical rod; the hole-punching drill bit is arranged on the moving block, and a hole-punching operation is performed by driving the hole-punching drill bit with the electric drill.

14. The portable woodworking hole puncher according to claim 13, wherein the connecting part is a connecting plate;
the hole-punching mechanism comprises a first connecting block and a second connecting block that are respectively hinged to two connecting plates, and the first vertical rods and the second vertical rod are respectively arranged on the first connecting block and the second connecting block; and
the connecting plate is provided with a scale for observing an angle of the hole-punching mechanism.

15. The portable woodworking hole puncher according to claim 14, further comprising a first limiting block and a second limiting block, wherein the first limiting block is arranged on the two first vertical rods, and the second limiting block is arranged on the second vertical rod for limiting a moving distance of the moving block.

16. The portable woodworking hole puncher according to claim 13, further comprising an elastic element, wherein the elastic element is sleeved on the second vertical rod and configured to provide a restoring force and a supporting force to the moving block to move away from the base plate.

17. The portable woodworking hole puncher according to claim 14, wherein the angle-locking assembly comprises a housing, a pull plate and a clamping rod, the housing is arranged on the first connecting block, the clamping rod is arranged inside the housing, and the pull plate is arranged at one end of the clamping rod; and
the angle-locking assembly further comprises a plurality of clamping holes arranged on the connecting plate, and the clamping rod is inserted into the clamping holes to lock the hole-punching mechanism.

18. The portable woodworking hole puncher according to claim 17, further comprising a sliding slot and sliding blocks, wherein the sliding slot is arranged on the connecting plate, the two sliding blocks are respectively arranged on the first connecting block and the second connecting block, and the sliding blocks are slidably arranged inside the sliding slot.

19. The portable woodworking hole puncher according to claim 18, further comprising a connecting bolt, wherein one end of the connecting bolt is threadedly connected inside the sliding block, the other end of the connecting bolt is provided with a handle, and a baffle plate is sleeved on the connecting bolt, with the baffle plate abutting against the connecting part to restrict rotation of the hole-punching mechanism.

20. The portable woodworking hole puncher according to claim 12, wherein the insertion rod is inserted into a bottom of the base plate; and
the positioning mechanism comprises connecting rods, an adjusting plate and an adjusting bolt, the connecting rod being arranged at one end of the base plate, two connecting rods being arranged in parallel, the adjusting plate being slidably arranged on the connecting rod, the adjusting bolt being threadedly arranged on the adjusting plate, and one end of the adjusting bolt abutting against an outer side of the connecting rod.
